(19) United States
(12) Patent Application Publication
(10) Pub. No.: US 2022/0388582 A1
(43) Pub. Date: Dec. 8, 2022

(54) System and Method for Providing Mobile Mental Health Therapy and Counseling Services

(71) Applicant: Doreen Upshaw, Pittsburgh, PA (US)

(72) Inventor: Doreen Upshaw, Pittsburgh, PA (US)

(21) Appl. No.: 17/883,319

(22) Filed: Aug. 8, 2022

Related U.S. Application Data
(63) Continuation-in-part of application No. 17/830,818, filed on Jun. 2, 2022.
(60) Provisional application No. 63/258,836, filed on Jun. 2, 2021.

(51) Int. Cl. B62D 47/00; B60N 2/005; B60N 2/24; B60N 3/00; B60N 3/04; B60R 13/00

(52) U.S. Cl. CPC B62D 47/00; B60N 2/005; B60N 2/24; B60N 3/001; B60N 3/04; B60R 13/00; H04N 7/183

(57) ABSTRACT

System and method for mobile mental health therapy and counseling services, including but not limited to play therapy services, art therapy services, and individual adult therapy services, the system comprising a motor vehicle comprising a driver area from which to operate the vehicle and a rear area comprising one large independent compartment intended for all therapy and counseling services for a client. The rear area is provided with complementary access and may comprise comfortable seating for traditional counseling services and may further comprise equipment for real-life and nurturing play, acting-out play, aggressive play, scary toys play, and creative expression play, gaming technology, and emotional release play that includes the use of art therapy materials, including kinetic sand and water tables.

### CROSS REFERENCE TO RELATED APPLICATIONS

This application is a continuation-in-part of U.S. patent application Ser. No. 17/830,818 filed Jun. 2, 2022, and claims the benefit of U.S. Provisional Patent Application No. 63/258,836, filed Jun. 2, 2021, the disclosures of which are hereby incorporated in their entireties by reference.

### BACKGROUND OF THE INVENTION

The importance of mental health becomes more evident in our society every day. Providing counseling and therapy services to children often encompasses novel and effective types of pediatric counseling techniques, such as play therapy. Present play therapy centers are implanted in fixed places to which the parents must go with their child, which is sometimes inconvenient, uncomfortable, and even difficult, depending on the distance from their home. In many underserved communities, individuals and families struggle to obtain access to therapy systems, resulting in years of unaddressed pain and mental health issues, particularly for those who face barriers to transportation. Recent research demonstrates that when mobile therapy services are provided in the form of a counselor coming to the patient's home and providing services therein, the results have mixed success due to family distractions, uncomfortable atmospheres, and invasions of privacy and confidentiality for the patient and the counselor. There exists an urgent need in these communities for the opportunity to receive mental health therapy and/or counseling services for both parents and children that are provided in a location which is private, safe, and directly outside their homes, such that participants have the ability to remain in the safety of their home or a location they are familiar with. There is further an urgent need that such services be available during convenient times and locations such as during a lunch break, in school during the school day, or in a community area.

### SUMMARY OF THE INVENTION

The present invention relates to a mobile vehicle for mobile mental health therapy and counseling services, with all technical means necessary to carry out therapy and/or counseling services in an area with appropriate resources, comfort, safety, and cleanliness. An object of the invention is to provide itinerant mental health therapy and counseling services for patients aged four years or older in a location that is convenient to them.

The present invention comprises a motor vehicle which has been provided with a driver area, from which to operate the vehicle, and a rear area which comprises a plurality of entrances/exits as well as a plurality of areas equipped for various therapy and counseling techniques that can be provided to a patient depending on their age and circumstances. The vehicle is further wrapped in a colorful logo design that is both appealing to the eye and capable of providing privacy to a participant inside the rear area from any windows in the vehicle.

The present invention is provided with two sources of electrical power, one comprising a source of 220 volts and another which is directly obtained from an electricity generator or transformer which can transform the 12 volts of the operation of the devices. The rear area is provided with electrical outlets which can supply electrical power for a variety of resources useful for providing therapy and counseling services within the vehicle, including but not limited to camera technology, gaming systems, computers, lighting, music players, control switches, exhaust fans, air conditioning units, and heating units.

### BRIEF DESCRIPTION OF THE DRAWINGS

The structure, operation and advantages of the present invention will become further apparent upon consideration of the following description taken in conjunction with the accompanying figures. The figures are intended to be illustrative, not limiting. Certain elements in some of the figures may be omitted, or illustrated not-to-scale, for illustrative clarity. In the drawings accompanying the description that follows, both reference numerals and legends may be used to identify elements. To the extent that legends are provided, they are not intended merely as an aid to the reader, and are not intended to be limiting in any way.

FIG. 1 is a side view of the system for providing mobile mental health therapy and counseling services, as viewed from an exterior vantage point.

FIG. 2 is a plan view of the system for providing mobile mental health therapy and counseling services.

### DESCRIPTION OF THE INVENTION

In the description that follows, numerous details are set forth in order to provide a thorough understanding of the present invention. It will be appreciated by those skilled in the art that variations of these details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

Addressing mental health issues in adults and in children often requires a provider of mental health therapy and counseling services to employ an arsenal of different techniques depending on the age of a patient. For example, traditional conversational counseling techniques may be most appropriate for providing mental health therapy and counseling services to adult patients, and typically requires comfortable seating in a safe and private area, while creative play is particularly important to effectively provide mental health therapy and counseling services to pediatric patients, and can include such activities as art and gaming, as well as imaginative play to process aggression or real world scenarios. Engaging in creative play therapy techniques typically requires specific equipment, a safe and private area, and the means for efficient and thorough cleanings between uses, among other requirements.

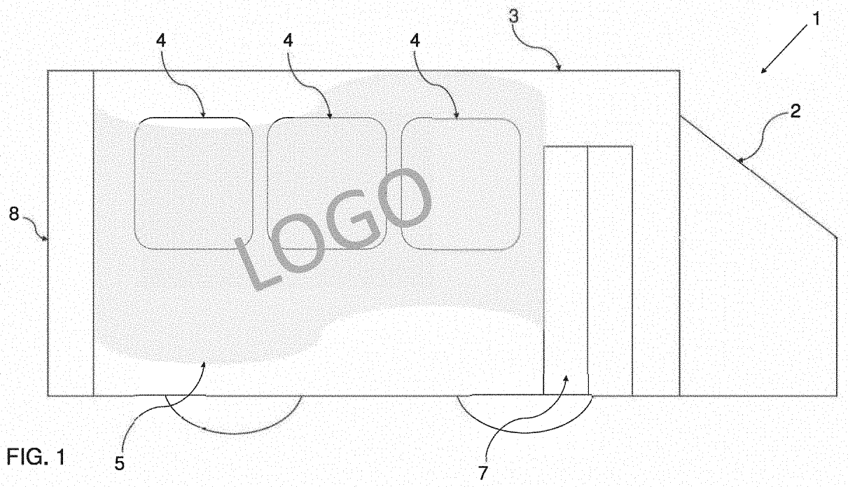

A non-limiting embodiment of the present invention, as shown in FIG. 1, is a system for providing mobile mental health therapy and counseling services, comprising a motor vehicle 1 having a driver area 2 and a rear area 3 for providing therapy and counseling services, the rear area being provided with side windows 4 which are covered by an exterior design façade 5 which provides an eye-catching logo in addition to providing privacy for participants receiving therapy and counseling services in the rear area 3. The motor vehicle 1 is provided with at least two entrances/exits, a driver area exit 6 and a main entrance 7. The motor vehicle 1 may optionally be provided with an accessibility entrance 8 equipped to accommodate participants who are not able to use main entrance 7, such as by employing a selectively deployable lift or ramp.

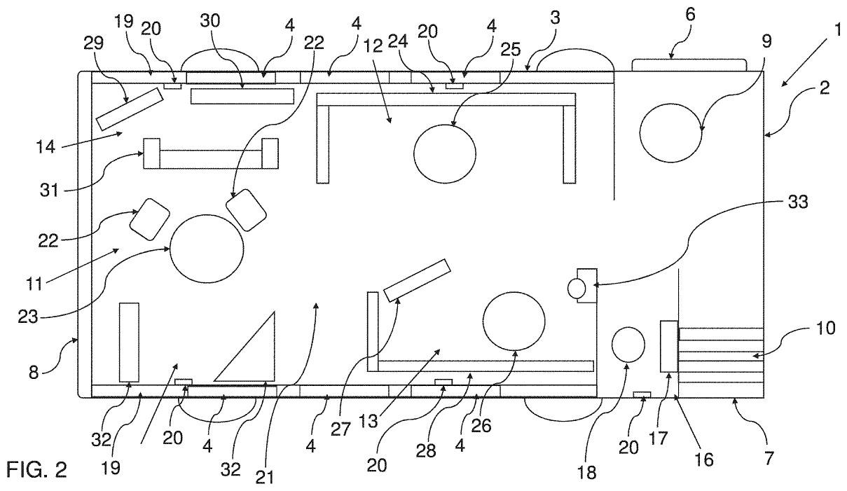

A plan view of the interior of a non-limiting embodiment of the system for mobile mental health therapy and counseling services is shown in FIG. 2. The driver area 2 is provided with a driver seat 9 at which a driver can comfortably sit to operate the motor vehicle 1. The driver area is further provided with a driver area exit 9 which the driver can use to enter or exit the vehicle.

The motor vehicle 1 further comprises a main entrance 7 equipped with stairs 10 which can be used by a participant to enter the rear area 3. The rear area 3 comprises a plurality of areas equipped to provide a plurality of mental health therapy and counseling services: a conversational counseling area 11, a “real-life” play area 12, an art therapy area 13, a gaming play area 14, and an aggression therapy area 15.

The rear area 3 may further comprise a therapist workstation 16 provided with a computer 17 and a seat 18 at which a provider of mental health therapy and counseling services may record information about upcoming, ongoing, or past sessions.

The motor vehicle 1 may be provided with a thermal insulating material 19 surrounding the interior walls of the rear area 3. The motor vehicle 1 may be further provided with an electrical power system comprising a plurality of electrical power outlets 20 integrated into the rear area 3 connected to an electrical power source of 220 volts or from an electricity generator or transformer capable of converting the electrical power from the electrical power source of 220 volts into 12 volts. The rear area may be further provided with a non-slip flooring 21 to provide a safe and comfortable space for participants.

The conversational counseling compartment 11 may be provided with a plurality of seats 22 and a table 23 at which a patient and a mental health therapy and counseling services provider can gather in comfort while engaging in traditional counseling activities. The conversational counseling area 11 may further be used by an adult guardian of a pediatric patient who may, for a variety of reasons, need to be present or nearby during therapy and/or counseling sessions for the pediatric patient.

The “real-life” play area 12 may be provided with a supply unit 24 which stores supplies and items appropriate for reenacting scenarios faced in the real word. Supply unit 24 further acts as a barrier providing separation and privacy for a patient engaging in imaginative play. The “real-life” play area 12 may be further provided with a table 25 which can be used to reenact real life scenarios or to create a surface upon with play items can be used.

The art therapy area 13 may be provided with a table 26 and an apparatus for artistic activities 27 suitable for engaging in creative arts activities in a therapeutic setting. The art therapy area 13 may be further provided with a supply unit 28 which stores art supplies appropriate for engaging in creative arts activities in a therapeutic setting, and which further acts as a barrier providing separation and privacy for a patient engaging in art therapy activities.

The gaming play area 14 may be provided with a computer 29 and a television 30 configured to allow for the playing of computer games and video games, as well as a seating unit 31. A patient engaging in gaming activities in a therapeutic setting may play computer games using the computer 29 or play video games using the television 30, and may be seated at seating unit 31 while playing games.

The aggression therapy area 15 may be provided with a plurality of supply units 32 which provide supplies appropriate for engaging in aggression therapy while further providing barriers for safety, separation and privacy for a patient engaging in aggression therapy.

The rear area 3 of the motor vehicle 1 may be further provided with camera technology 33 configured to record live camera footage from inside the rear area 3. A guardian of a pediatric patient may be provided with a mobile receiving unit configured to receive the live camera footage from the camera technology 33 in real time, such that they can monitor the session from a nearby area without having to be present inside the rear area 3 while the patient is provided with mental health therapy and counseling services. The camera technology 33 may be further configured to provide camera footage without an audio component, so as to permit a guardian to monitor the session without comprising the patient's privacy and security.

To provide mobile mental health therapy and counseling services, a provider of such services may schedule an appointment time and location with a patient or a patient's guardian. At the appropriate time, the provider may dispatch the motor vehicle 1 by operating the motor vehicle 1 from the driver area 2. Upon dispatch to the appropriate location, the provider may then enter the rear area 3 and prepare for the upcoming session, and optionally may utilize the therapist's workstation 16 to prepare for the session and record any relevant information. When the patient arrives, the patient may enter the rear area 3 via the main entrance 7 and may then be directed to a particular area depending on the type of mental health therapy and counseling services they are to receive, the determination of which is based on a number of factors to be determined by a provider of mental health therapy and counseling services. For example, an adult patient may be directed to the conversational counseling area 11, while a pediatric patient may be directed to the “real-life” play area 12.

In another non-limiting embodiment, the rear area 3 of the motor vehicle 1 may comprise a plurality of play and technology therapy stations provided with equipment to engage in the following types of pediatric therapy and counseling techniques: “real-life” play, nurturing play, “acting out” play, aggression play, “scary toys” play, and creative expression and emotional release that would include the use of art therapy materials including kinetic sand and water tables. The equipment may include, but is not limited to the following toys and materials: doll furniture (sturdy wood), Gumby (bendable nondescript figure), doll bed and clothes, bendable doll family, dolls, pacifier, plastic nursing bottle, chalkboard and chalk, dry erase board and markers, wood refrigerator, plastic or tin dishes, pitcher, plastic food, egg cartons, broom and dustpan, crayons, pencils, paper, toy watch, paints, painting easel, newsprint, paintbrushes, Long Ranger-type mask, tongue depressors, popsicle sticks, truck, car, airplane, tractor, boat, pounding bench and hammer, cymbals, toy soldiers and army equipment, sandbox, large spoon, funnel, sieve, pail, rubber snake, alligator, multi-color chalk and eraser, pans, silverware, dishpan, empty fruit and vegetable cans, Band-Aids, sponge, towel, soap, hairbrush, comb, transparent tape, building blocks, Play-Doh, clay, pipe cleaners, school bus, xylophone, drum, fireman's hat and other hats, zoo animals, farm animals, Bop bag (Bobo), handcuffs, toy gun, telephones, construction paper, rags or old towels, tinker toys, tissue, rubber knife, dart gun, medical kit, blunt scissors, play money, cash register, hand puppets (doctor, nurse, and other professionals), rope, purses, jewelry, kinetic sand, water table, markers, child-sized tables, child-sized chairs, adult-sized comfy chairs, small comfy couch, small items table, supply units, television, gaming systems, security camera monitoring system, gaming computer, and a therapist workstation.

The present application is also directed to the following clauses.

Clause 1: A method for providing mobile therapy and counseling services, comprising: scheduling an appointment time and location to provide mental health therapy and counseling services to a patient; dispatching a system for providing mobile mental health therapy and counseling services at the scheduled time and location; asking the patient to enter the system for providing mobile mental health therapy and counseling services; and providing mental health therapy and counseling services to the patient after they have entered the system for mobile mental health therapy and counseling services.

Clause 2: The method according to clause 1, wherein the system for providing mobile mental health therapy and counseling services comprises a motor vehicle comprising: a driver area and a rear area for providing mental health therapy and counseling services; the rear area comprising a plurality of areas for providing a variety of mental health therapy and counseling services.

Clause 3: The method according to clause 1, wherein the system for providing mobile mental health therapy and counseling services further comprises an electrical power system.

Clause 4: The method according to clause 1, wherein the system for providing mobile mental health therapy and counseling services further comprise an exterior design façade covering an exterior of the motor vehicle.

Clause 5: The method according to clause 1, wherein the system for providing mobile mental health therapy and counseling services further comprises a thermal insulating material integrated into the rear area of the motor vehicle.

Clause 6: The method according to clause 3, wherein the system for providing mobile mental health therapy and counseling services further comprises an electrical power system further comprises a plurality of electrical outlets integrated into the rear area of the motor vehicle.

Clause 7: The method according to clause 1, wherein the system for providing mobile mental health therapy and counseling services further comprises camera technology configured to record camera footage from inside the rear area.

Clause 8: The method according to clause 7, further comprising: using camera technology to record live camera footage from inside the rear area which can be received in real-time by a mobile receiving unit.

Clause 9: The method according to clause 1, wherein the system for providing mobile mental health therapy and counseling services further comprises a plurality of exits integrated into the motor vehicle, wherein at least one of the plurality of exits permits access to the rear area of the motor vehicle.

Clause 10: The method according to clause 1, wherein the system for providing mobile mental health therapy and counseling services further comprises a non-slip flooring material integrated with the rear area of the motor vehicle.

Clause 11: The method according to clause 1, wherein the plurality of areas in the rear area of the motor vehicle of the system for providing mobile mental health therapy and counseling services further comprises a therapist workstation including a computer and a seat.

Clause 12: The method according to clause 1, wherein the plurality of areas in the rear area of the motor vehicle of the system for providing mobile mental health therapy and counseling services further comprises a conversational counseling area including a table and a plurality of seats.

Clause 13: The method according to clause 1, wherein the plurality of areas in the rear area of the motor vehicle of the system for providing mobile mental health therapy and counseling services further comprises a gaming play area including a television and a computer.

Clause 14: The method according to clause 1, wherein the plurality of areas in the rear area of the motor vehicle of the system for providing mobile mental health therapy and counseling services further comprises an art therapy area including a table, a supply unit, and art supplies.

Clause 15: The method according to clause 1, wherein the plurality of areas in the rear area of the motor vehicle of the system for providing mobile mental health therapy and counseling services further comprises a “real-life” play area including a table, a supply unit, and items appropriate for reenacting real world scenarios.

Clause 16: The method according to clause 1, wherein the plurality of areas in the rear area of the motor vehicle of the system for providing mobile mental health therapy and counseling services further comprises an aggression play area including two supply units and items appropriate for aggression play therapy.

Clause 17: The method according to clause 1, wherein the system for providing mobile mental therapy and counseling services further comprises an accessibility entrance.

The invention claimed is:

1. A system for providing mobile mental health therapy and counseling services comprising a motor vehicle comprising: a driver area and a rear area for providing mental health therapy and counseling services; the rear area comprising a plurality of areas for providing a variety of mental health therapy and counseling services.

2. The system for providing mobile mental health therapy and counseling services according to claim 1, further comprising an electrical power system.

3. The system for providing mobile mental health therapy and counseling services according to claim 1, further comprising an exterior design façade covering an exterior of the motor vehicle.

4. The system for providing mobile mental health therapy and counseling services according to claim 1, further comprising a thermal insulating material integrated into the rear area of the motor vehicle.

5. The system for providing mobile mental health therapy and counseling services according to claim 1, wherein the electrical power system further comprises a plurality of electrical outlets integrated into the rear area of the motor vehicle.

6. The system for providing mobile mental health therapy and counseling services according to claim 1, further comprising camera technology configured to record footage from inside the rear area.

7. The system for providing mobile mental health therapy and counseling services according to claim 6, further comprising a mobile receiving unit configured to receive camera footage from the camera technology in real-time.

8. The system for providing mobile mental therapy and counseling services according to claim 1, further comprising a plurality of exits integrated into the motor vehicle, wherein at least one of the plurality of exits permits access to the rear area of the motor vehicle.

9. The system for providing mobile mental therapy and counseling services according to claim 1, further comprising a non-slip flooring material integrated with the rear area of the motor vehicle.

10. The system for providing mobile mental therapy and counseling services according to claim 1, wherein the plurality of areas in the rear area of the motor vehicle comprises a therapist workstation including a computer and a seat.

11. The system for providing mobile mental therapy and counseling services according to claim 1, wherein the plurality of areas in the rear area of the motor vehicle comprises a conversational counseling area including a table and a plurality of seats.

12. The system for providing mobile mental therapy and counseling services according to claim 1, wherein the plurality of areas in the rear area of the motor vehicle comprises a gaming play area including a television and a computer.

13. The system for providing mobile mental therapy and counseling services according to claim 1, wherein the plurality of areas in the rear area of the motor vehicle comprises an art therapy area including a table, a supply unit, and art supplies.

14. The system for providing mobile mental therapy and counseling services according to claim 1, wherein the plurality of areas in the rear area of the motor vehicle comprises a “real-life” play area including a table, a supply unit, and items appropriate for reenacting real world scenarios.

15. The system for providing mobile mental therapy and counseling services according to claim 1, wherein the plurality of areas in the rear area of the motor vehicle comprises an aggression play area including two supply units and items appropriate for aggression play therapy.

16. The system for providing mobile mental therapy and counseling services according to claim 1, further comprising an accessibility entrance.
